(19) United States
(12) Patent Application Publication
(10) Pub. No.: US 2006/0233386 A1
(43) Pub. Date: Oct. 19, 2006

(54) Measuring system for standardized testing of hearing aids

(75) Inventor: Gerhard Ach-Kowalewski, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/403,320

(22) Filed: Apr. 13, 2006

(30) Foreign Application Priority Data
Apr. 15, 2005 (DE) 10 2005 017 494.9

(51) Int. Cl. H04R 29/00

(52) U.S. Cl. 381/60

(57) ABSTRACT

Manually held external transmitting coils are used for standardized testing of hearing aids by means of a test box. Measurements using the hearing aid telephone coil are therefore cumbersome and difficult. There is therefore proposed a holder module connected both electrically and mechanically to the test box and having a receptacle for holding the hearing aid, a transmitting coil for producing an electromagnetic signal detectable by the hearing aid and with connecting means for electrically connecting the transmitting coil and a coupler connected to the hearing aid during measurement to the test box.

### CROSS REFERENCE TO RELATED APPLICATIONS

This application claims priority to the German Application No. 10 2005 017 494.9, filed Apr. 15, 2005 which is incorporated by reference herein in its entirety.

### FIELD OF INVENTION

The invention relates to a measuring system for standardized testing of hearing aids, comprising a test box with a test chamber for accommodating a hearing aid and with connecting means for electrical connections.

### BACKGROUND OF INVENTION

The fitting of a hearing aid to match a user's particular hearing loss is generally performed by a specially trained hearing aid acoustician equipped with special diagnostic and fitting tools for carrying out his work.

The known “UNITY 2” measurement and fitting system of Siemens Audiologische Technik GmbH comprises, for example, an audiometer module for measuring the individual hearing loss of a hearing aid wearer. The known measurement and fitting system additionally comprises a probe microphone module which can be used to measure e.g. the frequency response of a hearing aid when it is worn on a user's ear. The known measurement and fitting system further comprises a test box unit enabling standardized tests to be performed on a hearing aid, e.g. for carrying out measurements according to the IEC 118-7 or ANSI 3.22 standards.

### SUMMARY OF INVENTION

A test box can be used to measure the input and output characteristic of a hearing aid. The test box incorporates a test chamber in which the hearing aid under test can be inserted. The test chamber is generally surrounded by sound absorbing material.

A specific hearing aid measurement that can be carried out by means of the test box relates to the telephone coil, whereby an electromagnetic signal is produced by a transmitting coil and picked up by the hearing aid's telephone coil. The signal thus received passes through the signal processor in the hearing aid and is finally fed out as an acoustic signal. To measure the resulting signal, a coupler connected to the hearing aid is used which simulates the hearing response of a hearing aid wearer and converts the acoustic signal into an electrical signal which is finally fed to a processing unit.

For performing measurements in conjunction with the telephone coil of a hearing aid, a transmitting coil is incorporated in the known test box. However, this coil is not suitable for performing all the standardized measurements normally carried out for a hearing aid. For example, a measurement according to ANSI standard 3.22 (SPLITS measurement) is not possible using the test box of the known UNITY 2 measurement and fitting system. For this specific measurement the test box is provided with means for connecting an external transmitting coil. A known external coil is e.g. the Frye “telewand” in which the transmitting coil is incorporated in a hand-held housing. During the measurement, the telewand and the hearing aid to be measured are held against one another in such a way that optimum inductive signal transmission can take place.

The disadvantage with measurements in conjunction with the telewand is the cumbersome handling whereby the telewand and the hearing aid with which the measurement is to be performed have to be simultaneously hand-held. An object of the present invention is therefore to simplify the performance of standardized measurements for hearing aids using a test box.

This object is achieved by a measuring system for standardized measurement of hearing aids, comprising:
a test box (1) with a test chamber (2) for accommodating a hearing aid and with connecting means (3A to 3C) for electrical connections,
a holder module (10) with a receptacle for holding the hearing aid, a transmitting coil (12) for emitting an electromagnetic signal detectable by the hearing aid and with connecting means for electrically connecting the transmitting coil (12) and a coupler connected to the hearing aid during measurement to the test box (1).

The advantage of the invention is that, for performing measurements in conjunction with the telephone coil of a hearing aid, a telephone magnetic field simulator is used which has a receptacle, e.g. a flat plate, on which the hearing aid in question can be placed. In addition to the hearing aid, a coupler connected to the hearing aid during the measurement can also be likewise placed on the receptacle in the holder module. In addition, the holder module advantageously has electrical connections enabling the coupler or transmitting coil to be electrically connected to the test box in a simple manner. The hearing aid can be positioned on the receptacle in such a way that optimum signal transmission between the transmitting coil and the telephone coil in the hearing aid is achieved. Neither the hearing aid nor the transmitting coil needs to be manually held to perform the measurement. This make it easier to operate the signal generators and measuring instruments used for performing the measurement.

The use of a separate holder module connected in an electrically and mechanically detachable manner to the test box increases the functionality of the test box. As there is only limited space in the test box for mounting different transmitting coils, only one telephone magnetic field transmission can generally be measured according to a particular standard. By using holder modules with different transmitting coils, this measurement can in principle be extended to any number of different telephone magnetic field simulations.

The invention additionally offers the advantage that more precise measurement results can be achieved due to the increased ease of handling compared to the Frye telewand.

### BRIEF DESCRIPTION OF THE DRAWINGS

The invention will now be explained in greater detail with reference to an exemplary embodiment and the accompanying drawings in which:

FIG. 1 shows a holder module connectable to a test box and

FIG. 2 shows a side elevation of the holder module and an extension for a coupler connection.

### DETAILED DESCRIPTION OF INVENTION

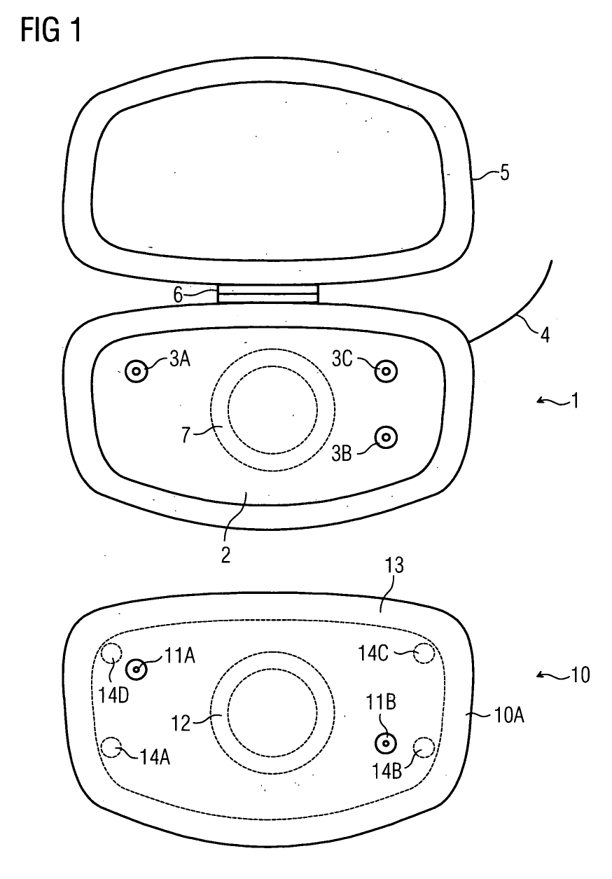

FIG. 1 shows a plan view of a test box 1 for performing standardized measurements on a hearing aid which can be inserted in a test chamber 2 for this purpose. The test box 1 has electrical connections 3A, 3B and 3C to which various devices required for performing measurements can be connected, such as a coupler connected to the hearing aid or an external transmitting coil. The test box 1 is connected to an external processing unit such as a PC via a data cable 4 via which test signals can be fed to the test box 1 and measurement signals read out.

To ensure that acoustic measurements remain as free as possible from external influences, the test chamber 2 is surrounded by sound absorbing material. The top of the test chamber 2 can be sealed by means of a cover 5 attached to the test box 1 via a hinge 6.

In addition to a microphone for picking up acoustic signals, hearing aids frequently also have a telephone coil for picking up inductive signals. To transmit a test signal to the telephone coil of a hearing aid, the test box 1 has a transmitting coil 7 on the underside of the test chamber 2.

Hearing aids sometimes require measurements according to different, particularly also country-specific standards. With regard to measurements in conjunction with the telephone coil, different transmitting coils must be used for this purpose. Because of its size, however, the test box 1 only has space for one particular transmitting coil 7. For measurement in conjunction with another transmitting coil, it is then necessary, for example, to connect an external transmitting coil to one of the electrical connections 3A to 3C. However, the handling of this additional transmitting coil in the confines of test chamber 2 is cumbersome and difficult. The invention therefore proposes a holder module 10, the top of which is essentially implemented as a flat plate 10A. The holder module 10 is likewise equipped with electrical connections 11A and 11B which can be connected to the electrical connections 3A to 3C of the test box 1 e.g. by connecting cables (not shown). On the underside of the holder module 10 is a transmitting coil 12 to which a test signal can be fed via one of the electrical connections, e.g. the connection 11A, which can then be fed out as an electromagnetic test signal and transmitted to the hearing aid to be measured. For the measurement, the hearing aid in question can be placed on top of the holder module 10. To read out an inductively transmitted test signal, the hearing aid is connected to a coupler which feeds out an electrical signal to the connection 11B. This signal is then fed via the test box 1 and the data cable 4 to the external processor unit (not shown) for further analysis.

The use of the holder module 10 considerably facilitates the performance of the measurement. The hearing aid under test can be placed and positioned on the holder module 10 so as to achieve optimum signal transmission between the transmitting coil 12 and the hearing aid. This obviates the need not only to replace the transmitting coil 7 present in the test box 1 but also to manipulate an external transmitting coil that has to be manually held, thereby providing a simple means of performing measurements using different transmitting coils.

As illustrated by the example in FIG. 1, the holder module 10 is designed so that it can be used as another cover for the test box 1 when the latter's cover 5 is hinged open. To ensure that is does not slide around on the test box 1, the holder module 10 has a circumferential edge 13 which engages in the test chamber 2. However, to perform a measurement in connection with the transmitting coil 12, the holder module 10 does not necessarily have to be mechanically connected to the test box 1. Likewise the test box 1 and the holder module 10 can be set up side by side. For this purpose there are four feet 14A to 14D on the underside of the holder module 10.

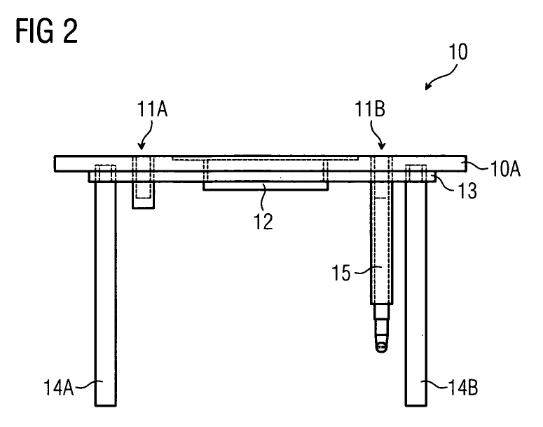

FIG. 2 shows the holder module 10 in side elevation. Visible in the drawing is the flat upper plate 10A which is used to hold a hearing aid and a coupler. On the underside can be seen the two front feet 14A and 14B on which the holder module 10 can be stood. The transmitting coil 12 is disposed on the underside of the flat plate in approximately the center of the holder module 10. For the electrical connection of the holder module 10, the jacks 11A and 11B are provided on the upper side of the flat plate 10A. The transmitting coil 12 and the coupler connected to the hearing aid under test can therefore be electrically connected via suitable plugs. In the example shown, the connection 11B for the coupler comprises an extension piece 15 whose end opposite the jack 11B is implemented as a plug to which a connecting cable can be connected.

With the holder module 10 according to the exemplary embodiment, the feet 14A to D, the transmitting coil 12 and the extension 15 for the electrical coupler connection can be screwed to the plate 10A so that the latter can be removed or replaced if necessary, thereby providing a simple means of using different transmitting coils or electrical connections.

1.-6. (canceled)

7. A measuring system for enabling standardized testing of hearing aids, the measuring system comprising:
a test box having a testing chamber for accommodating a hearing aid, the text box having a plurality of first connectors for establishing electrical connections; and
a carrier module comprising:
a receptacle for receiving the hearing aid, the hearing aid configured to be connected to a coupling device while testing the hearing aid;
a transmitting coil for generating an electromagnetic signal configured to be received by the hearing aid; and
a plurality of second connectors for electrically connecting the transmitting coil and the coupling device to the test box via the first connectors.

8. The measuring system according to claim 7, wherein the first and second connectors include plugs or jacks for establishing a detachable connection between the carrier module and the test box using at least one cable.

9. The measuring system according to claim 7, wherein the second connectors include an extension section for connecting the carrier module to the coupling device, the extension section configured to be detachably connected to the receptacle.

10. The measuring system according to claim 7, wherein the carrier module and the test box are detachably connected.

11. The measuring system according to claim 10, wherein the carrier module is a cap of the test box, the cap sized and configured to cover an upside of the test chamber.

12. The measuring system according to claim 7, wherein the receptacle is formed as a disc.
